(19) United States
(12) Patent Application Publication
(10) Pub. No.: US 2025/0117960 A1
(43) Pub. Date: Apr. 10, 2025

(54) POSE CALIBRATING METHOD, HOST, AND COMPUTER READABLE STORAGE MEDIUM

(71) Applicant: HTC Corporation, Taoyuan City (TW)

(72) Inventor: Yi-Chun Chen, Taoyuan City (TW)

(73) Assignee: HTC Corporation, Taoyuan City (TW)

(21) Appl. No.: 18/482,018

(22) Filed: Oct. 6, 2023

(51) Int. Cl. G06T 7/70; G06T 7/20; G06T 17/00

(52) U.S. Cl. CPC G06T 7/70; G06T 7/20; G06T 17/00; G06T 2207/20044

(57) ABSTRACT

The embodiments of the disclosure provide a pose calibrating method, a host, and a computer readable storage medium. The method includes: receiving a first pose of each of at least one target object from an external tracking device; receiving a first reference pose of a reference object from the external tracking device; tracking a second reference pose of the reference object; determining a converting relationship between the first reference pose and the second reference pose; and converting the first pose of each of the at least one target object into a corresponding second pose based on the converting relationship and accordingly providing a visual content of a reality service.

### BACKGROUND

### 1. Field of the Invention

The present disclosure generally relates to a pose determining mechanism, in particular, to a pose calibrating method, a host, and a computer readable storage medium.

### 2. Description of Related Art

See FIG. 1, which shows a schematic diagram of a tracking scenario. In FIG. 1, the user 10 can wear a head-mounted display (HMD) 11 that provides a visual content of a reality service (e.g., a virtual reality (VR) service). In the visual content (e.g., a VR content), the HMD 11 can show an avatar 12 corresponding to the user 10.

In one scenario, the avatar 12 may present the same gesture/posture as the user 10. That is, the avatar 12 can move in response to the movement of the user 10. For example, if the user 10 raises his/her left hand, the avatar 12 can accordingly raise the left hand therefore. If the user 10 nods his/her head, the avatar 12 can accordingly nod the head thereof. To achieve this purpose, an external tracking device 13 can be disposed near the user 10 for tracking the pose of each joint on the user 10, and the external tracking device 13 may provide the tracked pose of each joint on the user 10 to the HMD 11 for the HMD 11 to accordingly adjust the gesture/posture of the avatar 12.

However, since the coordinate systems used by the HMD 11 and the external tracking device 13 are usually different, the avatar 12 may not be correctly shown if the HMD 11 directly uses the information from the external tracking device 13 to adjust the gesture/posture of the avatar 12.

For example, assuming that the coordinate system used by the HMD 11 has an origin O2, and the coordinate system used by the external tracking device 13 has an origin O1. In this case, the external tracking device 13 may determine that the pose of the head of the user 11 is at a position with a coordinate (−2,−2) in the coordinate system used by the external tracking device 13, which is shown with “(−2,−2) @01” in FIG. 1.

In this case, if the HMD 11 directly uses the information from the external tracking device 13 to adjust the avatar 12, the head of the avatar 12 may be shown at a position with a coordinate (−2,−2) in the coordinate system used by the HMD 11, which is shown with “(−2,−2) @O2” in FIG. 1.

As can be seen from FIG. 1, the place where the avatar 12 is shown does not match the place where the user 10 actually locates, which may increase the difficulty of development.

### SUMMARY OF THE INVENTION

Accordingly, the disclosure is directed to a pose calibrating method, a host, and a computer readable storage medium, which may be used to solve the above technical problems.

The embodiments of the disclosure provide a pose calibrating method, including: receiving, by a host, a first pose of each of at least one target object from an external tracking device; receiving, by the host, a first reference pose of a reference object from the external tracking device; tracking, by the host, a second reference pose of the reference object; determining, by the host, a converting relationship between the first reference pose and the second reference pose; and converting, by the host, the first pose of each of the at least one target object into a corresponding second pose based on the converting relationship and accordingly providing a visual content of a reality service.

The embodiments of the disclosure provide a host including a storage circuit and a processor. The storage circuit stores a program code. The processor is coupled to the storage circuit and accesses the program code to perform: receiving a first pose of each of at least one target object from an external tracking device; receiving a first reference pose of a reference object from the external tracking device; tracking a second reference pose of the reference object; determining a converting relationship between the first reference pose and the second reference pose; and converting the first pose of each of the at least one target object into a corresponding second pose based on the converting relationship and accordingly providing a visual content of a reality service.

The embodiments of the disclosure provide a non-transitory computer readable storage medium, the computer readable storage medium recording an executable computer program, the executable computer program being loaded by a host to perform steps of: receiving a first pose of each of at least one target object from an external tracking device; receiving a first reference pose of a reference object from the external tracking device; tracking a second reference pose of the reference object; determining a converting relationship between the first reference pose and the second reference pose; and converting the first pose of each of the at least one target object into a corresponding second pose based on the converting relationship and accordingly providing a visual content of a reality service.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a tracking scenario.

FIG. 2 shows a schematic diagram of a host according to an embodiment of the disclosure.

FIG. 3 shows a flow chart of the pose calibrating method according to an embodiment of the disclosure.

FIG. 4 shows an application scenario according to an embodiment of the disclosure.

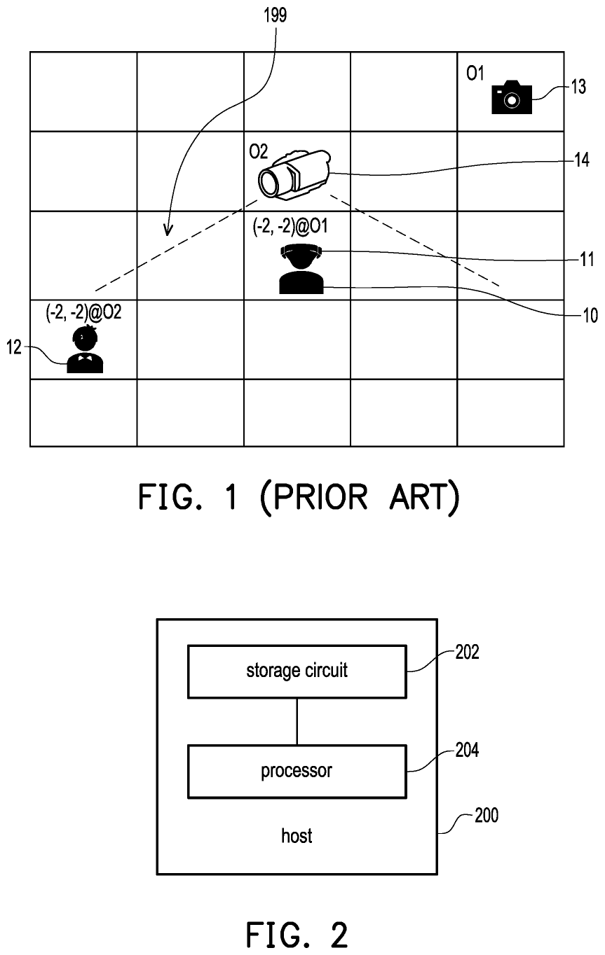

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

See FIG. 2, which shows a schematic diagram of a host according to an embodiment of the disclosure. In various embodiments, the host 200 can be any smart device and/or computer device that can provide visual contents of reality services such as virtual reality (VR) service, augmented reality (AR) services, mixed reality (MR) services, and/or extended reality (XR) services, but the disclosure is not limited thereto. In some embodiments, the host 200 can be a head-mounted display (HMD) capable of showing/providing visual contents (e.g., AR/VR contents) for the wearer/user to see. For better understanding the concept of the disclosure, the host 200 would be assumed to be the HMD for providing VR contents (e.g., the VR world) to the user, but the disclosure is not limited thereto.

In FIG. 2, the host 200 includes a storage circuit 202 and a processor 204. The storage circuit 202 is one or a combination of a stationary or mobile random access memory (RAM), read-only memory (ROM), flash memory, hard disk, or any other similar device, and which records a plurality of modules and/or a program code that can be executed by the processor 204.

The processor 204 may be coupled with the storage circuit 202, and the processor 204 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In some embodiments, the host 200 can be a computer and/or a server, and the processor 204 may provide the computed results (e.g., AR/VR contents) to other external display device(s) (e.g., the HMD), such that the external display device(s) can show the computed results to the user, but the disclosure is not limited thereto.

In the embodiments of the disclosure, the processor 204 may access the modules and/or the program code stored in the storage circuit 202 to implement the pose calibrating method provided in the disclosure, which would be further discussed in the following.

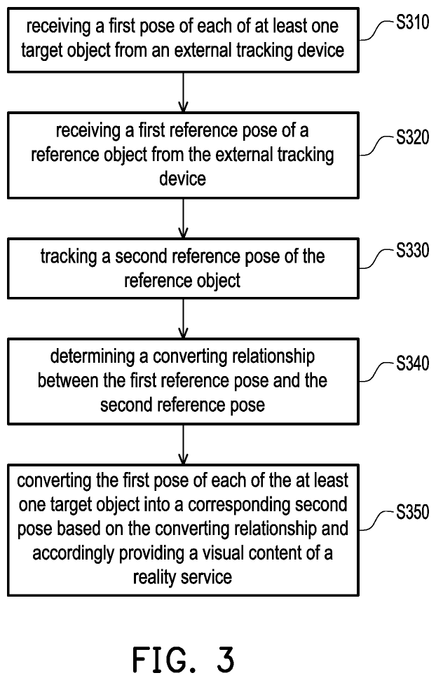

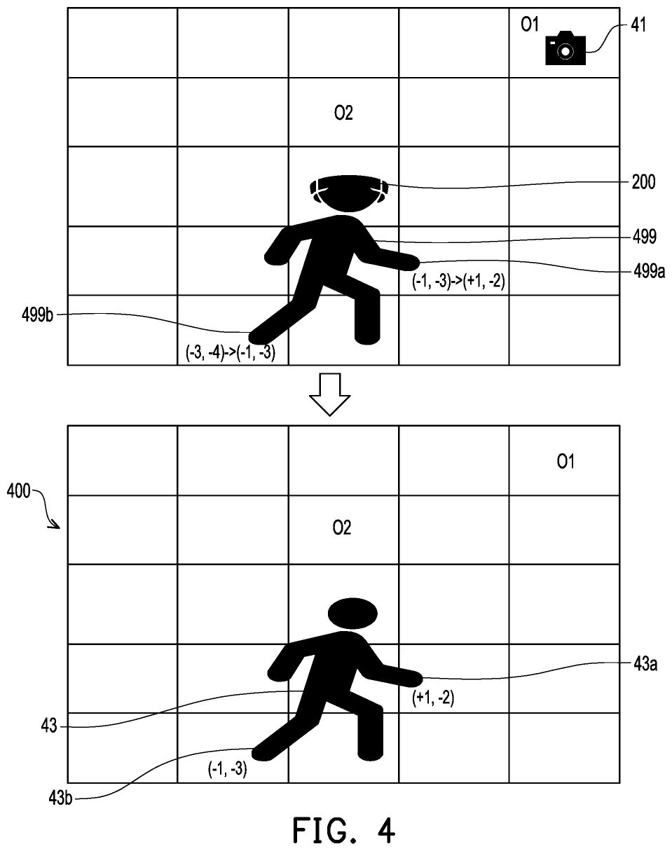

See FIG. 3, which shows a flow chart of the pose calibrating method according to an embodiment of the disclosure. The method of this embodiment may be executed by the host 200 in FIG. 2, and the details of each step in FIG. 3 will be described below with the components shown in FIG. 2. In addition, for better understanding the concept of the disclosure, FIG. 4 would be used as an example, wherein FIG. 4 shows an application scenario according to an embodiment of the disclosure.

In step S310, the processor 204 receives a first pose of each of at least one target object from an external tracking device 41.

In the embodiments of the disclosure, the external tracking device 41 can be used to capture images of at least one target object and accordingly determine, for example, the first pose of each of the target object.

In the embodiments of the disclosure, each of the mentioned pose can be characterized as a corresponding 6 degree-of-freedom (6DOF), but the disclosure is not limited thereto.

In one embodiment, the target object may include at least one first joint on a target body tracked by the external tracking device 41.

In FIG. 4, the body of the user 499 of the host 200 can be the considered target body. In this case, the external tracking device 41 may be used to capture images of the user 499 and determine the first pose of each first joint on the user 499. In some embodiments, the external tracking device 41 may use some existing pose detection algorithms to determine/track the first pose of each first joint on the user 499.

In one embodiment, the external tracking device 41 may be used to track the first poses of several particular first joints on the user 499, such as head, hands, shoulders, wrists, hips, knees, ankles, etc., but the disclosure is not limited thereto.

After determining/tracking the first poses of the considered first joints (e.g., the particular first joints in the above) on the user 499, the external tracking device 41 may transmit the determined first poses of the considered first joints to the host 200.

In one embodiment, a tracker (or multiple trackers) can be disposed on the user 499, and the external tracking device 41 can be also used to determine/track the pose of the tracker via, for example, inside-out tracking mechanism and/or outside-in tracking mechanism, but the disclosure is not limited thereto. After determining/tracking the pose of the tracker, the external tracking device 41 can also transmit the pose of the tracker to the host 200.

In some embodiments the tracker can be implemented as a wearable device worn on the user 499. In other embodiments, the tracker can be disposed at a place that can be observed by both of the host 200 and the external tracking device 41.

In step S320, the processor 204 receives a first reference pose of a reference object from the external tracking device 41.

In a first embodiment, the reference object considered in step S320 can be one or more of the first joints on the user 499.

For example, under the assumption that the host 200 is an HMD, the pose of the HMD can be understood as characterizing the first pose of the head of the user 499. In this case, the head of the user 499 can be considered as the reference object. Therefore, when the host 200 receives the first poses of the first joints (which include the head of the user 499), the processor 204 may extract the first pose of the head and consider the first pose of the head as the first reference pose of the reference object in step S320.

For another example, the host 200 may be connected with a handheld controller for the user 499 to interact with the visual content (e.g., the VR content), and the user 499 may hold the handheld controller in his/her hand, such that the pose of the handheld controller can be understood as characterizing the first pose of the hand of the user 499. In this case, the hand of the user 499 can be considered as the reference object. Therefore, when the host 200 receives the first poses of the first joints (which include the hand of the user 499), the processor 204 may extract the first pose of the hand and consider the first pose of the hand as the first reference pose of the reference object in step S320.

In a second embodiment, the reference object considered in step S320 can be the tracker. In this case, when the host 200 receives the pose of the tracker, the processor 204 can consider the received pose of the tracker as the first reference pose of the reference object in step S320.

In step S330, the processor 204 tracks a second reference pose of the reference object.

In the first embodiment, if the head of the user 499 is considered as the reference object, the processor 204 may directly determine the pose of the HMD (which can be regarded as a host pose of the host 200) as the second reference pose of the reference object. In one embodiment, the processor 204 may track the pose of the HMD via performing, for example, Simultaneous Localization and Mapping (SLAM).

In another embodiment, the processor 204 may obtain the pose of the HMD by using the outside-in tracking mechanism. That is, the processor 204 may receive the beacons from the lighthouse base stations nearby and accordingly determine the pose of the HMD, but the disclosure is not limited thereto.

In the first embodiment, if the hand holding the handheld controller is considered as the reference object, the processor 204 may determine the pose of the handheld controller (i.e., a controller pose of the handheld controller) as the second reference pose of the reference object. In one embodiment, the processor 204 may track the pose of the handheld controller via performing, for example, the inside-out tracking mechanism and/or the outside-in tracking mechanism, but the disclosure is not limited thereto.

In the second embodiment, if the tracker is considered as the reference object, the processor 204 may track the pose of the tracker a via performing, for example, the inside-out tracking mechanism and/or the outside-in tracking mechanism, and determine the pose of the tracker (i.e., the tracker pose) as the second reference pose of the reference object.

In step S340, the processor 204 determines a converting relationship between the first reference pose and the second reference pose.

In one embodiment, the processor 204 may characterize the first reference pose as a first vector in a first coordinate system of the external tracking device 41 and characterize the second reference pose as a second vector in a second coordinate system of the host 200. Next, the processor 204 may determine a vector difference between the first vector and the second vector, and determine the vector difference as the converting relationship.

In one embodiment, the processor 204 may determine the vector difference via subtracting the second vector from the first vector, but the disclosure is not limited thereto.

In detail, since the first coordinate system used by the external tracking device 41 may be different from the second coordinate system used by the host 200, step S340 can be understood as being used to determine the relative position between the first coordinate system and the second coordinate system. From another perspective, the converting relationship may be regarded as a transforming function that can be used to transform a particular coordinate in the first coordinate system into the corresponding coordinate in the second coordinate system.

In step S350, the processor 204 converts the first pose of each of the at least one target object into a corresponding second pose based on the converting relationship and accordingly provides a visual content of a reality service.

In one embodiment, step S350 can be understood as the processor 204 converting the first pose of each of the at least one target object into the corresponding second pose of each of the at least one target object.

In one embodiment, the processor 204 may determine the corresponding second pose via subtracting the vector difference from the first pose of each of the at least one target object.

In this case, the corresponding second pose of each of the at least one target object (e.g., the first joints on the user 499) can be understood as the corresponding pose of each target object in the second coordinate system used by the host 200.

For better understanding, it is assumed that the reference object considered in FIG. 4 is the head of the user 499. In addition, it is assumed that the origin of the first coordinate system is the origin O1, and the origin of the second coordinate system is the origin O2.

In this case, the external tracking device 41 would determine the pose of the head of the user 499 as the first reference pose of the reference object, which may be (−2,−2) (i.e., the first vector) in the first coordinate system. In addition, the processor 204 would determine the host pose of the host 200 as the second reference pose of the reference object, which may be (0,−1) (i.e., the second vector) in the second coordinate system.

Next, the processor 204 may determine the vector difference between the first vector and the second vector via subtracting the second vector (e.g., (0,−1)) from the first vector (e.g., (−2,−2)). In the scenario of FIG. 4, the processor 204 may determine the vector difference to be (−2,−1) as the converting relationship.

Afterwards, the processor 204 can determine the corresponding second pose of each target object (e.g., the first joints) based on the vector difference.

For example, if the external tracking device 41 determines that the first pose of the right hand 499a of the user 499 is (−1,−3) in the first coordinate system, the processor 204 can determine the corresponding second pose as (+1,−2) in the second coordinate system.

For another example, if the external tracking device 41 determines that the first pose of the left foot 499b of the user 499 is (−3,−4) in the first coordinate system, the processor 204 can determine the corresponding second pose as (−1,−3) in the second coordinate system.

For other target objects (e.g., other first joints on the user 499), the processor 204 can determine the corresponding second pose in the second coordinate system based on the teachings in the above, which would not be further discussed.

In one embodiment, when providing the visual content of the reality service, the processor 204 can determine at least on second joint on an avatar (e.g., an VR avatar) based on the corresponding second pose of each of the target object, wherein the at least one second joint one-to-one corresponds to the at least one first joint, and the avatar corresponds to the target body. Next, the processor 204 may show the avatar in the visual content of the reality service, wherein each of the at least one second joint on the avatar is shown with the corresponding second pose.

In FIG. 4, the processor 204 may show the avatar 43 corresponding to the body of the user 499 in the visual content 400 of the reality service. As can be seen from FIG. 4, the second joints on the avatar 43 are shown with the corresponding second pose.

For example, the right hand 43a on the avatar 43 may correspond to the right hand 499a of the user 499. In this case, the corresponding second pose of the right hand 43a may be the corresponding second pose of the right hand 499a, i.e., (+1,−2) in the second coordinate system. Therefore, the right hand 43a of the avatar 43 can be shown with the corresponding second pose, i.e., (+1,−2).

For another example, the left foot 43b on the avatar 43 may correspond to the left foot 499b of the user 499. In this case, the corresponding second pose of the left foot 43b may be the corresponding second pose of the left foot 499b, i.e., (−1,−3) in the second coordinate system. Therefore, the left foot 43b of the avatar 43 can be shown with the corresponding second pose, i.e., (−1,−3).

Likewise, the processor 204 can show other second joints on the avatar 43 with the corresponding second pose based on the teachings in the above, which would not be further discussed.

As can be seen from FIG. 4, the way how the gesture/posture/place of the avatar 43 is shown has been matched the gesture/posture/place of the user 499, which may decrease the difficulty of development.

The disclosure further provides a computer readable storage medium for executing the pose calibrating method. The computer readable storage medium is composed of a plurality of program instructions (for example, a setting program instruction and a deployment program instruction) embodied therein. These program instructions can be loaded into the host 200 and executed by the same to execute the pose calibrating method and the functions of the host 200 described above.

In summary, in the embodiments of the disclosure, if there exists a reference object that is observable to both of the external tracking device and the host, the external tracking device and the host can individually track the pose of the reference object, and the host can accordingly determine the relative position between the first coordinate system used by the external tracking device and the second coordinate system used by the host. With the relative position, the host can convert the first pose of each target object (e.g., first joints on the user) into the corresponding second pose, such that the virtual object (e.g., second joints on the avatar) corresponding to the target object can be shown with the corresponding second pose. Accordingly, the way how the gesture/posture/place of the avatar is shown in the visual content (e.g., the VR content) can match the gesture/posture/place of the user, which may decrease the difficulty of development.

In addition, since the gesture/posture/place of the avatar shown in the visual content matches the gesture/posture/place of the user, the user can feel more immersive during watching the visual content. Moreover, since the solution provided by the disclosure can be understood as automatically correcting the projection place of the avatar in the visual content, the user does not have to worry about where to place the external tracking device.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

To the claims:

1. A pose calibrating method, comprising:
receiving, by a host, a first pose of each of at least one target object from an external tracking device;
receiving, by the host, a first reference pose of a reference object from the external tracking device;
tracking, by the host, a second reference pose of the reference object;
determining, by the host, a converting relationship between the first reference pose and the second reference pose; and
converting, by the host, the first pose of each of the at least one target object into a corresponding second pose based on the converting relationship and accordingly providing a visual content of a reality service.

2. The method according to claim 1, wherein the at least one target object comprises at least one first joint on a target body tracked by the external tracking device, and the step of providing the visual content of the reality service comprises:
determining at least on second joint on an avatar based on the corresponding second pose of each of the target object, wherein the at least one second joint one-to-one corresponds to the at least one first joint, and the avatar corresponds to the target body; and
showing the avatar in the visual content of the reality service, wherein each of the at least one second joint on the avatar is shown with the corresponding second pose.

3. The method according to claim 1, wherein the step of determining, by the host, the converting relationship between the first reference pose and the second reference pose comprises:
characterising the first reference pose as a first vector in a first coordinate system of the external tracking device and characterising the second reference pose as a second vector in a second coordinate system of the host;
determining a vector difference between the first vector and the second vector; and
determining the vector difference as the converting relationship.

4. The method according to claim 3, wherein the step of determining the vector difference between the first vector and the second vector comprises:
determining the vector difference via subtracting the second vector from the first vector.

5. The method according to claim 4, wherein the step of converting the first pose of each of the at least one target object into the corresponding second pose based on the converting relationship comprises:
determining the corresponding second pose via subtracting the vector difference from the first pose of each of the at least one target object.

6. The method according to claim 3, wherein the first coordinate system is different from the second coordinate system.

7. The method according to claim 1, wherein the host is a head-mounted display providing the visual content of the reality service, the reference object is a head of a target body, and the step of tracking the second reference pose of the reference object comprises:
determining a host pose of the host as the second reference pose of the reference object, wherein the at least one target object comprises the head of the target body.

8. The method according to claim 1, wherein the reference object is a hand of a target body, the host is connected with a handheld controller hold by the hand of the target body, and the step of tracking the second reference pose of the reference object comprises:
determining a controller pose of the handheld controller as the second reference pose of the reference object, wherein the at least one target object comprises the hand of the target body.

9. The method according to claim 1, wherein the reference object is a tracker, and the step of tracking the second reference pose of the reference object comprises:
determining a tracker pose of the tracker as the second reference pose of the reference object, wherein the tracker does not belong to the at least one target object.

10. The method according to claim 1, wherein the reality service is a virtual reality service, and the visual content is a virtual reality content.

11. A host, comprising:
a non-transitory storage circuit, storing a program code; and
a processor, coupled to the non-transitory storage circuit and accessing the program code to perform:
receiving a first pose of each of at least one target object from an external tracking device;
receiving a first reference pose of a reference object from the external tracking device;
tracking a second reference pose of the reference object;
determining a converting relationship between the first reference pose and the second reference pose; and
converting the first pose of each of the at least one target object into a corresponding second pose based on the converting relationship and accordingly providing a visual content of a reality service.

12. The host according to claim 11, wherein the at least one target object comprises at least one first joint on a target body tracked by the external tracking device, and the processor performs:
determining at least on second joint on an avatar based on the corresponding second pose of each of the target object, wherein the at least one second joint one-to-one corresponds to the at least one first joint, and the avatar corresponds to the target body;
showing the avatar in the visual content of the reality service, wherein each of the at least one second joint on the avatar is shown with the corresponding second pose.

13. The host according to claim 11, wherein the processor performs:
characterising the first reference pose as a first vector in a first coordinate system of the external tracking device and characterising the second reference pose as a second vector in a second coordinate system of the host;
determining a vector difference between the first vector and the second vector; and
determining the vector difference as the converting relationship.

14. The host according to claim 13, wherein the processor performs:
determining the vector difference via subtracting the second vector from the first vector.

15. The host according to claim 14, wherein the processor performs:
determining the corresponding second pose via subtracting the vector difference from the first pose of each of the at least one target object.

16. The host according to claim 13, wherein the first coordinate system is different from the second coordinate system.

17. The host according to claim 11, wherein the host is a head-mounted display providing the visual content of the reality service, the reference object is a head of a target body, and the processor performs:
determining a host pose of the host as the second reference pose of the reference object, wherein the at least one target object comprises the head of the target body.

18. The host according to claim 11, wherein the reference object is a hand of a target body, the host is connected with a handheld controller hold by the hand of the target body, and the processor performs:
determining a controller pose of the handheld controller as the second reference pose of the reference object, wherein the at least one target object comprises the hand of the target body.

19. The host according to claim 11, wherein the reference object is a tracker disposed on a target body, and the processor performs:
determining a tracker pose of the tracker as the second reference pose of the reference object, wherein the tracker does not belong to the at least one target object.

20. A non-transitory computer readable storage medium, the computer readable storage medium recording an executable computer program, the executable computer program being loaded by a host to perform steps of:
receiving a first pose of each of at least one target object from an external tracking device;
receiving a first reference pose of a reference object from the external tracking device;
tracking a second reference pose of the reference object;
determining a converting relationship between the first reference pose and the second reference pose; and
converting the first pose of each of the at least one target object into a corresponding second pose based on the converting relationship and accordingly providing a visual content of a reality service.
